(19) United States
(12) Patent Application Publication
(10) Pub. No.: US 2024/0095922 A1
(43) Pub. Date: Mar. 21, 2024

(54) Wet Read Apparatus and Method to Confirm On-site FNA Biopsy Specimen Adequacy

(71) Applicants: University of Massachusetts, Boston, MA (US); Worcester Polytechnic Institute, Worcester, MA (US)

(72) Inventors: Young H. Kim, Westborough, MA (US); Ali Akalin, Worcester, MA (US); Kwonmoo Lee, Acton, MA (US)

(21) Appl. No.: 18/253,302

(22) PCT Filed: Nov. 22, 2021
(86) PCT No.: PCT/US2021/060298

§ 371 Date: May 17, 2023

Related U.S. Application Data
(60) Provisional application No. 63/117,254, filed on Nov. 23, 2020.

(51) Int. Cl. G06T 7/00; G06V 10/774; G06V 10/82; G06V 20/69

(52) U.S. Cl. CPC G06T 7/0014; G06V 10/774; G06V 10/82; G06V 20/693; G06V 20/698; H04N 23/695

(57) ABSTRACT

A system for evaluating a cell sample may comprise a specimen slide scanner, a computer-based image analyzer, and an evaluation subsystem. The specimen slide scanner may be configured to acquire images of an entire surface of a microscope slide upon which the cell sample is mounted. The computer-based image analyzer may be configured to identify one or more follicular clusters within each of the images acquired by the specimen slide scanner. The evaluation subsystem may be configured to (i) compare a number of follicular clusters identified by the computer-based image analyzer to an adequacy threshold, and (ii) present an adequacy notification to a user when the number of the follicular clusters identified by the computer-based image analyzer exceeds the adequacy threshold.

### RELATED APPLICATION

This application claims the benefit of U.S. Provisional Application No. 63/117,254, filed on Nov. 23, 2020. The entire teachings of the above application are incorporated herein by reference.

### BACKGROUND

Fine needle aspiration (FNA) biopsy of thyroid nodules is a safe, cost-effective, and accurate diagnostic procedure, which has been in use for the past four decades in the USA. More than 600,000 thyroid FNAs were performed in the United States in 2015 alone. Between 5% and 10% of FNAs are non-diagnostic (i.e., producing inconclusive results) due to, for example, one or more of (i) cystic fluid or bloody smears in the aspirated sample, (ii) operator experience, (iii) needle type, (iv) aspiration technique, (v) vascularity of nodule, and (vi) the criteria used to judge the adequacy of the specimen. The failure to adequately obtain satisfactory biopsy samples poses a delay in patient treatment because the patient must return for a repeated FNA. There is up to a 7% malignancy rate in patients with initial non-diagnostic FNA, and returning patients lose a precious opportunity to get immediate treatment.

In the current standard of care, interpretation of FNA results is performed in a cytology department well after the biopsy procedure is completed. Pathologists wait until unstained images are stained to verify that the cell slide sample obtained from the patient is adequate. Staining causes the nuclei of follicular cells to be dyed blue and other cells (e.g., red blood cells) to be dyed red, so that follicular cells are easily distinguished from other cells. The slide must have at least six follicular clusters to be diagnosable.

### SUMMARY

The described embodiments are directed to detecting follicular clusters in an unstained cell sample on a microscope slide, and at the sample collection site, confirming based on the detected follicular clusters if the sample is adequate for diagnostic evaluation. Because the confirmation is made at the sample collection site, samples do not need to be transported to a cytology lab for staining to determine if the samples are adequate. Health care personnel at the sampling site informed right away as to whether or not the FNA sample is adequate. If the FNA sample is not adequate, a decision to acquire additional FNA samples from the patient can be made before the patient leaves the sampling facility. This eliminates the need for a possible revisit, and expedites the diagnosis and treatment for patients.

The described embodiments are directed to an effective system to assess FNA biopsy sample adequacy, and detect inadequate samples in situ with a simple, low-cost instrument.

FNA samples are complex mixtures composed of target cell clusters, red blood cells, white blood cells, and various fibers. Their irregular shapes make computational image analysis a challenging task. Recent advancements in deep learning have shown, however, that computers can learn from the data and outperform humans in complex tasks, including image classification and audio recognition, without handcrafted feature detection. By taking advantage of deep learning, the described embodiments improve diagnostic accuracy and minimize non-diagnostic rates in FNA of a thyroid nodule using phase-contrast images from unstained FNA samples.

To improve diagnostic accuracy and minimize non-diagnostic rates, the described embodiments are directed to a method of and apparatus for performing computer-based wet reads capable of confirming adequacy of FNA sampling. The described embodiments facilitate the performance of FNAs by clinicians in an outpatient setting, and to immediately determine if the specimen represents an adequate sample, at the time of the procedure, without special staining or cytologist analysis. Current guidelines generally require that a satisfactory FNA sample contains at least 6 clusters of well-preserved samples, with each cluster containing 10 to 15 cells. Such an assessment is feasible given recent advances in artificial intelligence techniques.

In current practice, interpretations of FNA results are performed in the cytology department well after the biopsy procedure is completed. If the sample is determined to be non-diagnostic, the patient would eventually have to come back to repeat the procedure. The described embodiments utilize computer-assisted analysis of cell count to determine specimen adequacy, so that the clinician may be notified immediately if further aspirations are needed, thereby eliminating the need to call back patients for future appointments—a significant improvement over the 5-20% call back rate under currently known best practices. The described embodiments may be applied to any form of FNA, and have the potential to immensely affect clinical care.

In one aspect, the invention may be a system for evaluating a cell sample, comprising a specimen slide scanner configured to acquire images of an entire surface of a microscope slide upon which the cell sample is mounted, and a computer-based image analyzer configured to identify one or more follicular clusters within each of the images acquired by the specimen slide scanner. The system may further comprise an evaluation subsystem configured to (i) compare a number of follicular clusters identified by the computer-based image analyzer to an adequacy threshold, and (ii) present an adequacy notification to a user when the number of the follicular clusters identified by the computer-based image analyzer exceeds the adequacy threshold.

The computer-based image analyzer may comprise a neural network, which may be a convolutional neural network. The cell sample may be an unstained cell sample, and the neural network may be trained using training images labeled based on corresponding stained images. The cell sample may be a thyroid fine needle aspiration (FNA) specimen. The specimen slide scanner may further comprise a microscope, a mechanical stage configured to be movable in at least two dimensions with respect to the microscope, and a motor controller configured to drive motors coupled to the mechanical stage to move the mechanical stage. The s camera may convey images to a recording device configured to receive the images and store the images in storage media. A controller coupled to the recording device and the motor controller may facilitate moving the mechanical stage with respect to the camera, and storing images of a specimen slide mounted to the mechanical stage as the mechanical slide steps through multiple locations of the slide in a field of view of the camera. The adequacy threshold may be six follicular clusters, such that at least six follicular clusters are required to determine that the cell sample is diagnosable. The system may further include a post-processor configured to distinguish between a sample image that is suitable for training purposes and a sample image that is not suitable for training purposes.

In another aspect, the invention may be a method of evaluating a cell sample that comprises acquiring, using a specimen slide scanner, images of an entire surface of a microscope slide upon which the cell sample is mounted. The method may further comprise identifying, using a computer-based image analyzer, one or more follicular clusters within each of the images acquired by the specimen slide scanner. The method may further comprise comparing a number of follicular clusters identified by the computer-based image analyzer to an adequacy threshold and presenting an adequacy notification to a user when the number of the follicular clusters identified by the computer-based image analyzer exceeds the adequacy threshold.

The method may further comprise using a computer-based image analyzer that is a neural network. The method may further comprise using a computer-based image analyzer that is a convolutional neural network. The method may further comprise training the neural network using training images labeled based on corresponding stained images, wherein the cell sample is an unstained cell sample. The method may further comprise acquiring the cell sample as a thyroid fine needle aspiration (FNA) specimen. The method may further comprise providing the specimen slide scanner as a microscope, a mechanical stage configured to be movable in at least two dimensions with respect to the microscope, and a motor controller configured to drive motors coupled to the mechanical stage to move the mechanical stage. The method may further comprise conveying images, from the camera, to a recording device configured to receive the images and store the images in storage media. The method may further comprise coupling a controller to the recording device and the motor controller to facilitate moving the mechanical stage with respect to the camera, and storing images of a specimen slide mounted to the mechanical stage as the mechanical slide steps through multiple locations of the slide in a field of view of the camera. The method may further comprise setting the adequacy threshold to six follicular clusters, such that at least six follicular clusters are required to determine that the cell sample is diagnosable. The method may further comprise distinguishing between a sample image that is suitable for training purposes and a sample image that is not suitable for training purposes.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A shows an example embodiment of a computer-based imaging and evaluation system according to the invention.

FIG. 1B shows image acquisition with respect to certain patients in an example embodiment.

FIGS. 2A, 2B, 2C and 2D depict example image types that represent the same region.

FIGS. 3A and 3B illustrate an example embodiment of a cost-effective automated slide scanner to facilitate efficient acquisition of images, according to the invention.

FIG. 4 shows an example scan path for capturing images of a slide, according to the invention.

FIG. 5 shows an example FNA training pipeline according to the invention.

FIGS. 6A through 6D show examples of object detection on unstained images by Faster R-CNN.

FIG. 7 shows an example of hierarchical bootstrapping.

FIGS. 8A and 8B show statistical data for the bootstrapped samples.

FIGS. 9A and 9B show threshold performance and a precision-recall curve, respectively.

### DETAILED DESCRIPTION

A description of example embodiments follows.

The teachings of all patents, published applications and references cited herein are incorporated by reference in their entirety.

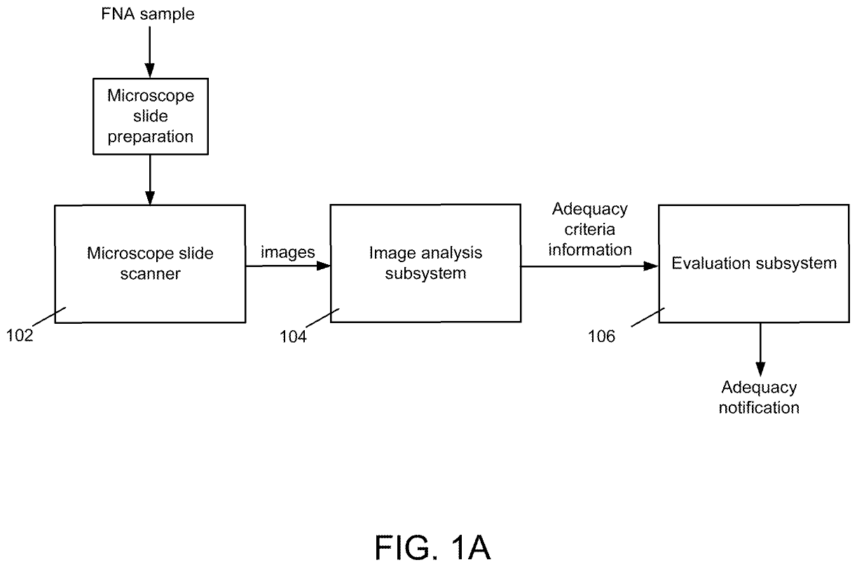

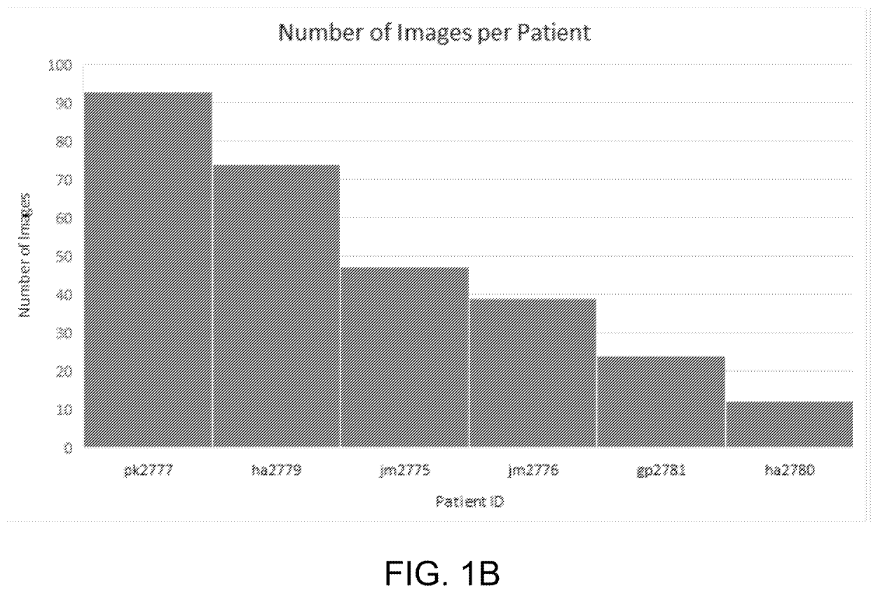

The described embodiments are directed to a computer-based imaging and evaluation system that facilitates wet reading of unprocessed FNA specimens and reports sampling adequacy associated with those FNA specimens. An example embodiment of this computer-based imaging and evaluation system, shown in FIG. 1A, includes a microscope slide scanning device 102 that captures images of the FNA sample on a microscope slide, and a computer-based image analysis subsystem 104 that determines if certain criteria associated with sample adequacy are present in the FNA sample. An evaluation subsystem 106 compares a number of criteria associated with sample adequacy to an adequacy threshold, and presents an adequacy notification to a user (e.g., health care providers collecting the FNA samples) when the adequacy threshold is equaled or exceeded.

### Image Acquisition and Preparation

In an example embodiment, images of unstained and stained cells smeared on the glass slide are taken using a phase-contrast microscope and Amscope USB camera. The size of the glass slides was 75 by 26 mm and about 1 mm thick. The samples were taken from six patients in total, and the number of images taken from each patient is shown in FIG. 1B. Two patients (pk2777 and ha2779) for this example have the most images but only secretion/artifact class without follicular clusters. Other patients have about a 1:4 ratio of follicular cluster and secretion/artifact.

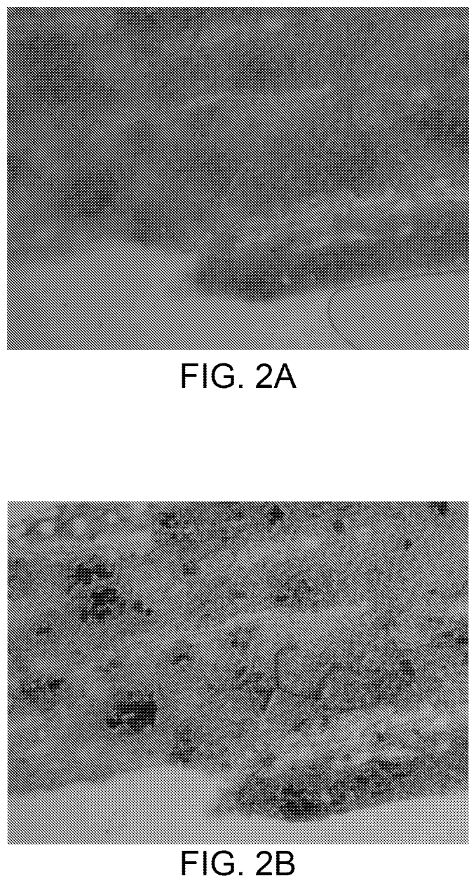

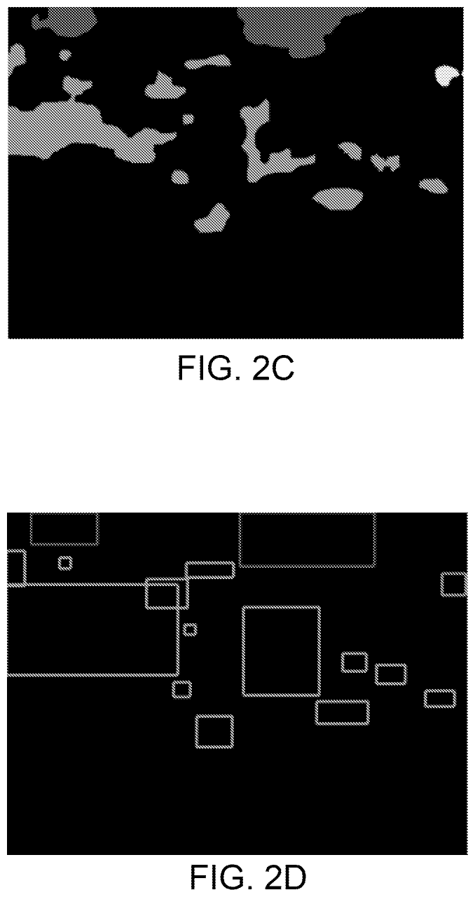

Each image is saved to, for example, PNG format, with 2592×1944 pixels. 20× magnification may be used to take images of unstained slides for training and testing the model, and 100× magnification was used to take more detailed images of stained slides for the labeling purposes. FIGS. 2A, 2B, and 2C show three example image types that represent the same region. FIG. 2A shows the original image for training, taken at 2× magnification. FIG. 2B shows a stained image taken at 2× magnification. The blue and purplish regions indicate the follicular clusters. FIG. 2C shows a labeled image with follicular cluster labeled in red and secretion/artifact in green & blue color unstained images (e.g., FIG. 2A) and stained images (e.g., FIG. 2B) are not perfectly aligned, but they were good enough to create an accurate label as shown in FIG. 2C. The label has four categories in total, each indicated by the color black, red, blue, and green. Black represents the background, and others represent follicular clusters and secretion. Initially, the label only had two categories, black and white, but the multi-category label was made to help the model learn the hard examples because the model incorrectly predicted some of them as follicular clusters. FIG. 2D shows bounding boxes generated based on the labels from FIG. 2C, and which form the training data set for the object detection described herein.

There are five types of white blood cells: neutrophils, lymphocytes, eosinophils, monocytes, basophils. Among them, the macrophage is the biggest concern because of its size (20-30 mm) and morphological similarity with follicular cells. However, with enough magnification, a trained expert can quickly identify follicular cells against white cells. Since unstained images with follicular cluster labels are not publicly available, we have labeled unstained images with expert pathologists.

For generalizability, the model needs to perform well for any patients. Therefore, the Images from six patients were combined, shuffled and randomly split into training (70%), validation (15%), and test (15%) set as shown in Table 1.

TABLE 1
Total Images from six patients split into
training, validation and test sets.

| | Follicular | Secretion/Artifact | Total |
|---|---|---|---|
| Training Set | 40 | 163 | 203 |
| Validation Set | 8 | 35 | 43 |
| Test Set | 8 | 35 | 43 |
| Total | 56 | 233 | 289 |

The images are augmented with horizontal flip only. The Deep Learning models first train using the training set images and evaluate its learning performance using the validation set. It ends the training if it sees the sign of overfitting, where training score continues to decrease but validation score increases continuously. At the end, the model predicts follicular clusters for the unstained images in the test set to show the model performance described herein.

### Slide Scanning Device

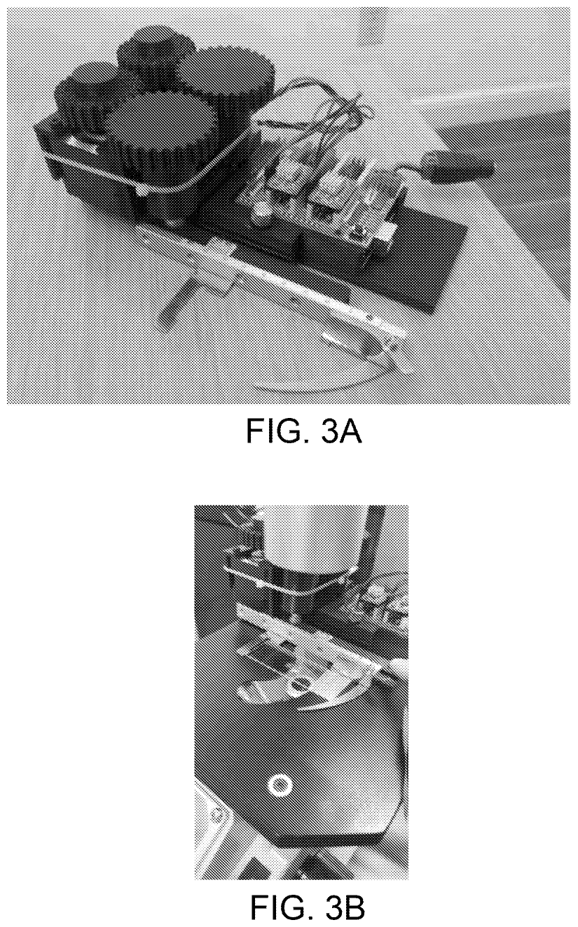

FIGS. 3A and 3B illustrate an example embodiment of a cost-effective automated slide scanner to facilitate efficient acquisition of images. FIG. 3A shows an example embodiment of a point-of-care slide screening device, and FIG. 3B shows the slide screening device of FIG. 3A integrated with a phase-contrast microscope.

The slide-screening device is designed to attach to any type of microscope and provide an easy mechanism for acquiring orderly images of the entire slide surface. For the example embodiment, an OMAX mechanical stage was chosen as the foundation to develop automated capabilities. This mechanical stage may be associated with any microscope platform and provide capabilities to move a slide front and back and left and right using small control knobs. This device was automated by mounting two 26Ncm NEMA 17 motors next to the knobs and connecting them with large gears. A 12V, 2 Amp DC power supply was used to power the motors in the example embodiment. The mounting frames and gears were all custom designed and 3D printed to fit desired constraints.

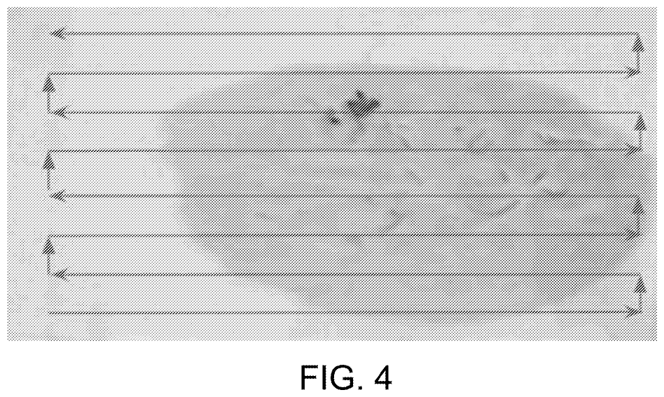

An Arduino CNC shield is used as the motor controller in the example embodiment because it is very small, inexpensive, and can be operated through a serial port interface. The Arduino mounts directly to the device on the clamp platform. The entire device fits in a footprint about 6 inches by 3 inches, stands less than 3 inches tall, and is lightweight and easily attaches to any microscope with a simple hand clamp, as shown in FIGS. 3A and 3B. Python script facilitates the interface between the Arduino and an Amscope USB camera through the serial port connection, and further facilitates recording images. The script sends commands to incrementally step through all locations on a slide, taking pictures at each step in the order (i.e., image scan path), as shown for example in FIG. 4. Other paths for capturing images of the entire slide may alternatively be used.

### Object Detection Techniques

Instead of pixelwise classification in semantic segmentation, object detection, which draws a rectangular box, is an easier task. The goal of the described embodiments is to screen an adequacy of the slide, so accurate segmentation of the follicular clusters is not necessary. Counting follicular clusters per image suffices the need. Therefore, several object detection models were explored.

Among various object detection models, some have the fast inference time such as YOLO and Single Shot Detector, while other models have higher accuracy with slow inference time. Our criteria for choosing the model is the high accuracy since slow inference time is not a problem if an image can be processed within a second. After experimenting with many models provided by Tensorflow Object Detection API, the Faster R-CNN with Inception-Resnet backbone and atrous convolutions was chosen because it showed the highest F1 score on our dataset.

Faster R-CNN is a two-stage object detection technique. In general, two-stage architecture benefits from higher performance in return for longer inference time than one stage architecture. The first stage is the region proposal network, which takes the extracted features from CNN and indicates possible regions of interest in rectangles. In the second stage, those regions go through the ROI pooling layer to have the same size and multiple FC layers to classify regions and draw the boundary box for each region.

### Quantification and Statistical Analysis

For object detection, the F1 score metric was used instead. To understand the F1 score, we first define what True Positive (TP), True Negative (TN), False Negative (FN), and False Positive (FP) means. TP represents the correct prediction of the location of the follicular cluster. TN represents the correct prediction of background location by not detecting any follicular cluster. FN means predicting a region to be a background location when that region has a follicular cluster. FP represents predicting a region to be a follicular cluster when that region is a background. By inputting the numbers defined above, precision and recall are calculated. Then the F1 score is calculated using the formulas in (2).

Precision=TP/(TP+FP)

Recall=TP/(TP+FN)

F1 Score=2*(Precision*Recall)/(Precision+Recall) (1)

### Post-Processing

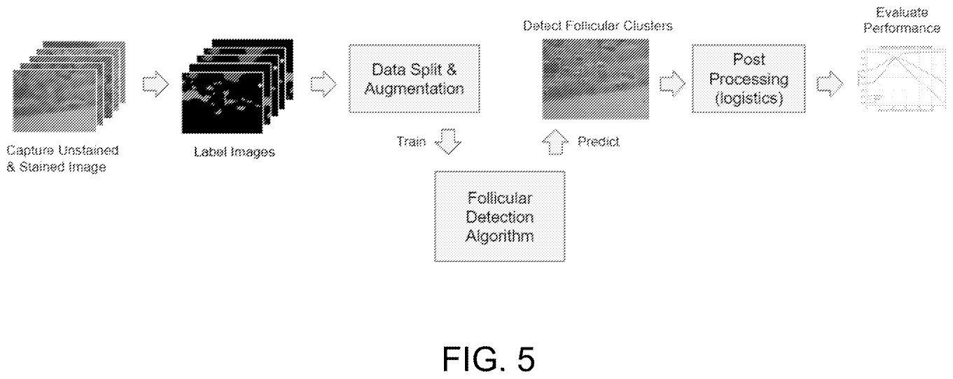

The dataset and model are improved by utilizing the expert's knowledge and mimicking what a pathologist would do in certain situations. When labeling images, distinguishing which image is usable for training improved the quality of images and the model's performance. For example, follicular cells clouded too darkly by blood are ignored since such clouded cells are hard to diagnose even for an expert pathologist. Also, individual follicular cells separated from each other were ignored because follicular clusters with at least 10 to 15 follicular cells are necessary for diagnosis. Further, cells that are separated are likely to be white cells, since follicular cells tend to cluster together. The minimum number of follicular clusters that a slide must have to be diagnosable is generally agreed to be six. The described embodiment pipeline maintains this threshold minimum number of follicular clusters as a user-definable parameter, since varying this threshold value can yield higher precision in return for lower recall and vice versa. The FNA screening pipeline of the example embodiment is shown in FIG. 5, which shows the FNA screening pipeline as comprising data acquisition, preparation model training, object detection, post processing, and evaluation.

### Object Detection Per Image Statistic

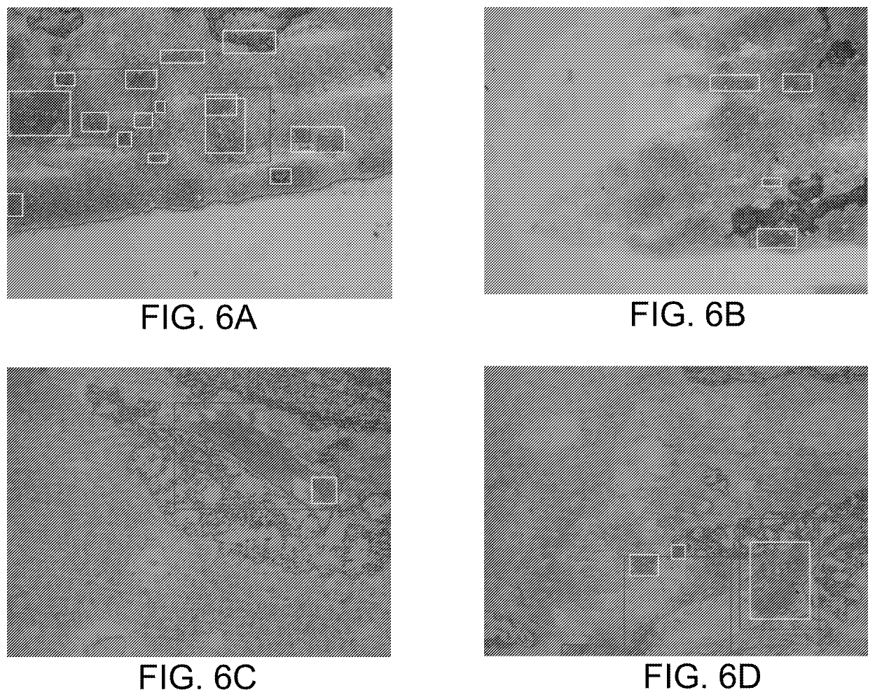

We counted an overlap greater than 50% between the predicted box and the ground truth box to be a true positive. If the region has a ground truth box without a predicted box, it is a false negative. If the region does not have a ground truth box but has a predicted box, it is a false positive. We did not count true negatives since true negative is not necessary to calculate precision, recall, and F1 score. Any images that only yield false positives were ignored from evaluation since a pathologist would also skip the hard to diagnose images. Also, only the follicular cluster class was counted, not the secretion/artifact class since secretion/artifact class only serves the purpose of providing hard false positive examples to the model. Some examples of object detection on unstained images are shown in FIGS. 6A through 6D. Among 43 images in the test set, there were 16 true positives, eight false positives, and three false negatives. As a result, the precision was 0.842, the recall was 0.667, and the F1 score was 0.744.

### Simulate Object Detection Per Slide Using Bootstrapping

The per-image statistic does not fully reflect the model's ability to screen a slide. To evaluate the deep learning model's ability to accurately assess the adequacy of the slide, we need multiple slides in a test set. However, we only have a test set representing images from one slide. Therefore, multiple slides with (positive) and without (negative) adequate follicular cluster samples were simulated by Bootstrapping the test set. Bootstrapping is a random resampling method with replacement to get multiple sets from a set.

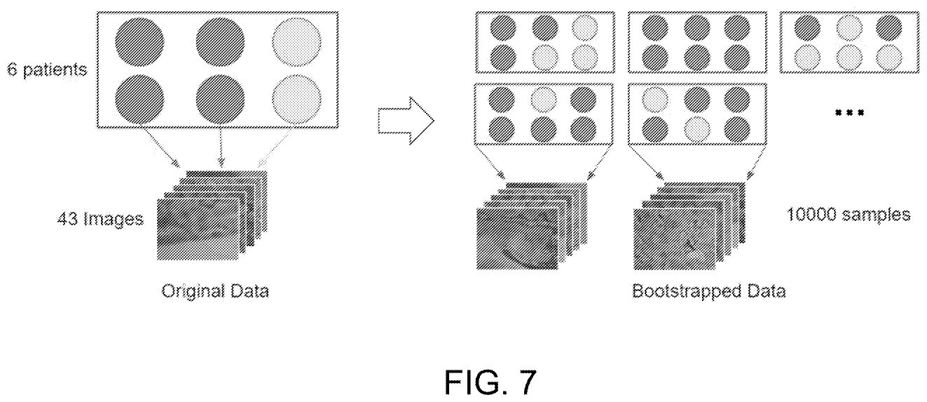

In particular, hierarchical bootstrapping was done because our dataset can be viewed as multilevel data, in which the first level corresponds to patients and the second level corresponds to the images of the patients. Hierarchical bootstrapping allows more balanced sampling of positive and negative cases than normal bootstrapping. In normal bootstrapping, ratio of number of positives to negatives was about 1:20. In hierarchical bootstrapping, the ratio is about 1:3. The hierarchical bootstrapping specific to our dataset is illustrated in FIG. 7, in which a red circle represents a patient with follicular clusters in images, and a green circle represents a patient without any follicular clusters in images. First, six patients with repetition were sampled. Then, 43 images were sampled with repetition from sampled 6 patients to form one bootstrap sample. By repeating these steps, 10,000 bootstrap samples were generated.

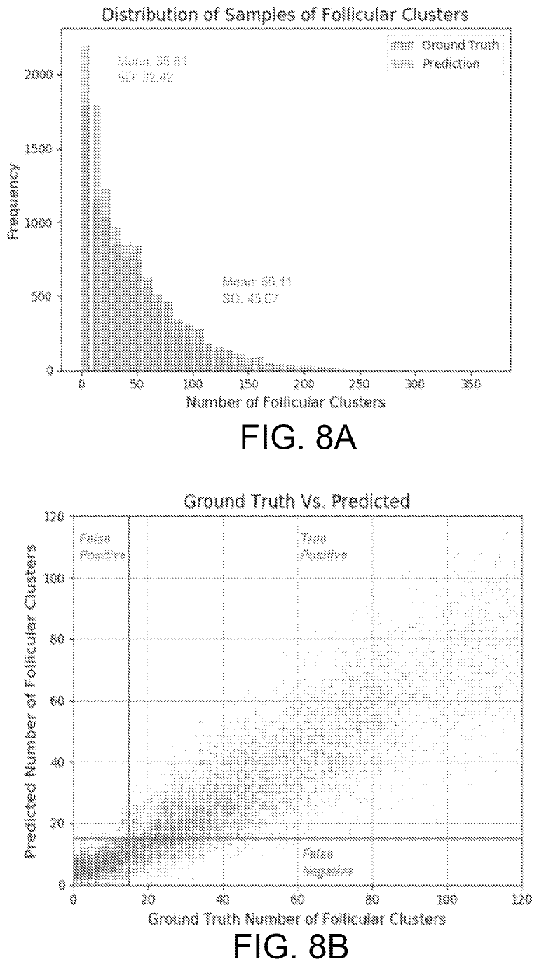

For each bootstrapped sample, there are 43 images with corresponding object detection predictions and ground truth images. The bar graph in FIG. 8A shows that the distribution shown in orange (prediction) is more skewed to the left than the distribution shown in blue (ground truth). This indicates that the model predicted less follicular clusters than the actual number of follicular clusters. The scatter plot in FIG. 8B has red lines indicating the minimum threshold value of 15 set by the user. These red lines separate the plot into four quadrants. By counting every point per quadrant, the total number of true positive, true negative, false negative, and false positive are found. The number of true positives and true negatives are the most abundant and the number of false positives is the lowest.

Based on the number of true positive, true negative, false negative, and false positive found, the precision, recall, and F1 scores were calculated according to the equations from (2). Precision was 0.989, Recall was 0.873, and the F1 score was 0.928. Clinically, it is more costly to have false positive (Type 1 Error) than the false negative. The model incorrectly screened a slide to be adequate when it isn't so pathologist would find out the slide's inadequacy after staining the slide. Then the patient would have to come back for the second FNA. Therefore, our model, which has a higher precision than recall is better than the opposite case. High precision and low recall imply that the model is careful not to make any mistake but has trouble finding some hidden follicular clusters. This aligns with the findings in the Object Detection Per Image Statistic section.

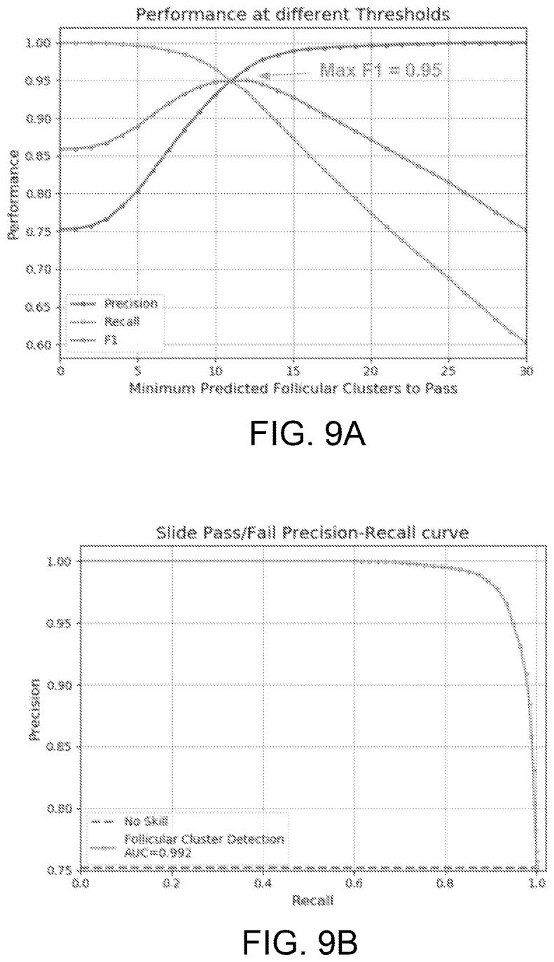

Evaluating threshold values ranging from 0 to 30, the model's performance peaks at threshold value 11, as shown in FIG. 9A. In the example embodiment, the user can increase the threshold to get higher precision or lower the threshold to get a higher recall. The AUC of 0.992 in the precision-recall curve, as depicted in FIG. 9B, shows that our pipeline works well in a range of threshold values. Note that the F1 score of about 0.85 at a minimum threshold value of 0 means that anyone could achieve the F1 score of about 0.85 if every incoming slide is assumed to be adequate. This is because the original test set used for bootstrapping had about 25 follicular clusters. If we bootstrapped the test set with lower follicular clusters, the F1 score at minimum threshold value 0 would be lower.

As with any other deep learning model, the collection of more FNA samples from new patients will make the model more robust. Also, including more categories in the label can allow the model to diagnose the follicular cells' malignancy in an unstained slide. To do that, taking unstained images in (100×) magnification for training would be necessary. Finding general regions where follicular clusters exist is possible but distinguishing between individual cells such as follicular cells and macrophage cell is difficult in the current magnification (20×).

The example embodiments may utilize stained images for labeling the follicular clusters. Alternatively, the model may be trained by synthetically staining the unstained images by the image-to-image translation method. By adding color information to the unstained image, the object detection can better distinguish follicular cluster.

A high F1 score in screening adequacy of unstained slides proves that the example embodiment of an AI-assisted follicular detection system can screen an inadequate FNA biopsy sample with reliable accuracy. The proposed follicular cluster detection pipeline can be used by a clinician who performs thyroid FNA in the outpatient clinic. Based on the computer-assisted analysis of cell counts with specimen adequacy, the clinician will immediately determine if further aspirations are needed. Moreover, the pipeline can be applied to any other form of FNA in many benign or malignant diseases, so there is a potential to be an immense impact on clinical practice.

While example embodiments have been particularly shown and described, it will be understood by those skilled in the art that various changes in form and details may be made therein without departing from the scope of the embodiments encompassed by the appended claims.

What is claimed is:

1. A system for evaluating a cell sample, comprising:
a specimen slide scanner configured to acquire images of an entire surface of a microscope slide upon which the cell sample is mounted;
a computer-based image analyzer configured to identify one or more follicular clusters within each of the images acquired by the specimen slide scanner; and
an evaluation subsystem configured to (i) compare a number of follicular clusters identified by the computer-based image analyzer to an adequacy threshold, and (ii) present an adequacy notification to a user when the number of the follicular clusters identified by the computer-based image analyzer exceeds the adequacy threshold.

2. The system of claim 1, wherein the computer-based image analyzer comprises a neural network.

3. The system of claim 2, wherein the neural network is a convolutional neural network.

4. The system of claim 2, wherein the cell sample is an unstained cell sample, and the neural network is trained using training images labeled based on corresponding stained images.

5. The system of claim 1, wherein the cell sample is a thyroid fine needle aspiration (FNA) specimen.

6. The system of claim 1, wherein the specimen slide scanner further comprises a microscope, a mechanical stage configured to be movable in at least two dimensions with respect to the microscope, and a motor controller configured to drive motors coupled to the mechanical stage to move the mechanical stage.

7. The system of claim 6, wherein the camera conveys images to a recording device configured to receive the images and store the images in storage media.

8. The system of claim 7, wherein a controller coupled to the recording device and the motor controller facilitates moving the mechanical stage with respect to the camera, and storing images of a specimen slide mounted to the mechanical stage as the mechanical slide steps through multiple locations of the slide in a field of view of the camera.

9. The system of claim 1, wherein the adequacy threshold is six follicular clusters, such that at least six follicular clusters are required to determine that the cell sample is diagnosable.

10. The system of claim 1, further including a post-processor configured to distinguish between a sample image that is suitable for training purposes and a sample image that is not suitable for training purposes.

11. A method of evaluating a cell sample, comprising:
acquiring, using a specimen slide scanner, images of an entire surface of a microscope slide upon which the cell sample is mounted;
identifying, using a computer-based image analyzer, one or more follicular clusters within each of the images acquired by the specimen slide scanner; and
comparing a number of follicular clusters identified by the computer-based image analyzer to an adequacy threshold; and
presenting an adequacy notification to a user when the number of the follicular clusters identified by the computer-based image analyzer exceeds the adequacy threshold.

12. The method of claim 11, further comprising using a computer-based image analyzer that is a neural network.

13. The method of claim 11, further comprising using a computer-based image analyzer that is a convolutional neural network.

14. The method of claim 12, further comprising training the neural network using training images labeled based on corresponding stained images, wherein the cell sample is an unstained cell sample.

15. The method of claim 12, further comprising, further comprising acquiring the cell sample as a thyroid fine needle aspiration (FNA) specimen.

16. The method of claim 11, further comprising providing the specimen slide scanner as a microscope, a mechanical stage configured to be movable in at least two dimensions with respect to the microscope, and a motor controller configured to drive motors coupled to the mechanical stage to move the mechanical stage.

17. The method of claim 16, further comprising conveying images, from the camera, to a recording device configured to receive the images and store the images in storage media.

18. The method of claim 17, further comprising coupling a controller to the recording device and the motor controller to facilitate moving the mechanical stage with respect to the camera, and storing images of a specimen slide mounted to the mechanical stage as the mechanical slide steps through multiple locations of the slide in a field of view of the camera.

19. The method of claim 11, further comprising setting the adequacy threshold to six follicular clusters, such that at least six follicular clusters are required to determine that the cell sample is diagnosable.

20. The method of claim 11, further comprising distinguishing between a sample image that is suitable for training purposes and a sample image that is not suitable for training purposes.
